(19) United States
(12) Patent Application Publication
(10) Pub. No.: US 2015/0073875 A1
(43) Pub. Date: Mar. 12, 2015

(54) SYSTEM AND METHOD FOR ACQUIRING, PROCESSING AND PRESENTING INFORMATION OVER THE INTERNET

(71) Applicants: Ashfaq Rahman, Bellevue, WA (US); Sabria Arefin, Bellevue, WA (US)

(72) Inventors: Ashfaq Rahman, Bellevue, WA (US); Sabria Arefin, Bellevue, WA (US)

(21) Appl. No.: 14/169,122

(22) Filed: Jan. 30, 2014

Related U.S. Application Data
(60) Provisional application No. 61/758,760, filed on Jan. 30, 2013.

(51) Int. Cl. G06Q 10/06; G06Q 50/00

(52) U.S. Cl. CPC G06Q 10/06393; G06Q 50/01
USPC 705/7.39

(57) ABSTRACT

Systems and methods are described for generating a business score and a health score for a business. Business information data sources are queried to extract independent business ratings from each data source. The independently retrieved business ratings are given weighted values based on the scope and authority for each source. An aggregate business score is generated from each of the retrieved business ratings and their weighted values. The aggregate business score is thus a single value based on multiple business information sources. A business health score is further determined by the number of online events a business receives over a period of time and whether or not the business is still exists,

### RELATED APPLICATIONS

This application claims the benefit of U.S. Provisional Application No. 61/758,760 filed 30 Jan. 2013.

### SUMMARY OF THE INVENTION

An apparatus for generating a business score for display on a video display is described. The apparatus comprises a CPU coupled to a memory for executing software instructions; a network interface coupled to the CPU for data communications; a display device, coupled to the CPU, for providing information to a user of the device; and a machine readable storage, coupled to the CPU, containing software modules. The software modules are programmed to receive a first rating (R1) for a business from a first data source, wherein the first rating is based on a numeric value from a maximum possible value (R1_{MAX}). The modules are further programmed to assign a first weighted value (W1) to the first rating. The modules are further programmed to receive a second rating (R2) for the business from a second data source, wherein the second rating is based on a numeric value from a maximum possible value (R2_{MAX}). The modules are further programmed to assign a second weighted value (W2) to the second rating, wherein the first weighted value and the second weighted value equal 1. The modules are further programmed to calculate the business score (BS) for the business based on the following calculation

BS=(((R1/R1_{MAX})*100)*W1)+(((R2/R2_{MAX})*100)*W2).

Lastly, The modules are further programmed to communicate the business score to a video display communicatively coupled to the apparatus.

An apparatus for generating a business health score for display on a video Display is described. The apparatus comprises a CPU coupled to a memory for executing software instructions; a network interface coupled to the CPU for data communications; a display device, coupled to the CPU, for providing information to a user of the device; and machine readable storage, coupled to the CPU, containing software modules. The software modules are programmed to determine if a business is closed and generating a closed indicator (A1). The software modules are further programmed to determine a first number of events for the business from a first data source and generating a first event value (E1). The software modules are further programmed to determine a second number of events for the business from a second data source and generating a second event value (E2). The software modules are further programmed to calculate the health score (HS) for the business based on the calculation of

HS=A1+E1+E2.

Lastly, The software modules are further programmed to communicate the health score to a video display communicatively coupled to the apparatus.

### BACKGROUND OF THE INVENTION

Web crawlers are often used to gather data from large information portals found in websites and other information portals. However, acquiring this information often poses many challenges. Search Engines and information portals attempt to prohibit or hinder web crawlers from acquiring their data in order to reduce the load on theft servers. Additionally, the web crawlers from certain geographic locations are often blocked as well.

Once data are obtained, its analysis and aggregation can pose further issues when such data comes from different data structures and formats. Additionally, once such data are analyzed and aggregated it can further be difficult to present the information in a concise and understandable way to users. As such, systems and methods are described that improve on current means of data acquisition, aggregation, and presentation.

### BRIEF DESCRIPTION OF THE DRAWINGS

In the following description, for the purposes of explanation, numerous specific details are set forth in order to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with other implementations as well. By the same token, however, no single feature or features of any described implementation should be considered essential to the invention, as other implementations of the invention may omit such features.

FIG. 1 illustrates a server architecture for searching and crawling business information from multiple data sources.

FIG. 2 illustrates a flow process for searching and extracting business information.

FIG. 3 illustrates a flow process for searching and extracting business information.

FIG. 4 illustrates a scalable architecture for an Information Portal.

FIG. 5 illustrates an embodiment of a server architecture for a Mobile Ad Service.

FIG. 6 illustrates services used to receive and process advertisement requests from a client computing device.

FIG. 7 illustrates a flow process for determining whether a business is closed.

FIG. 8 illustrates a computing system for calculating a business' online activity.

FIG. 9 illustrates an architecture for a local business search solution.

FIG. 10 illustrates an example of scalable architecture 1000 for searching for business information.

### DETAILED DESCRIPTION OF THE INVENTION

Numerous online information portals exist for providing information on local businesses. However, users (e.g., people searching for such information through a network such as the Internet) may need to visit many of these sources to obtain sufficient information about a business. For example, a user can find information about a business by visiting websites and information portals such as YAHOO, YELP, MANTA, CITYSEARCH, PATCH, GOOGLE, TWITTER, YOUTUBE, FACEBOOK, FOURSQUARE, GOOGLE PLACES, GOOGLE LOCAL, INSIDERPAGES, GROUPON, TWITTER, FACEBOOK, LIVING SOCIAL and LINKEDIN to name a few. Throughout this application, the phrase “information portal” refers to an Internet based information site or portal offering information about businesses. Visiting multiple information portals can be time consuming and often result in conflicting or inconsistent information. For example, YAHOO may present information about a restaurant in a different way than GOOGLE, thus making it difficult for a user to determine similarities in content presentation between information portals. Additionally, the type of information may vary between information portals. YELP may provide reviews on a restaurant, yet fail to include information on the restaurant's owners, how long they have been in business, location, etc. However, GOOGLE PLACES may provide this information. As such, an aggregate rating, calculated from multiple information portals, may be beneficial for a user seeking an objective rating of a business.

Another hurdle a user faces when obtaining information on businesses is filtering results by location. Often times a user wants to find a restaurant in a specific neighborhood of a city and not the city as a whole. For a large city like New York, searching for a restaurant by city name can be overwhelming and of little value. If a user is seeking a restaurant in Hell's Kitchen, they may not want to search by city or even zip code. They may want to have a well-defined neighborhood of Hell's Kitchen. As such, well defined neighborhoods may be useful to users seeking businesses in a non-traditional geographic location.

Once an aggregate rating for a business is received, it may be beneficial to know how recent the rating is. For example, if a business has excellent online ratings, the value is diminished if no reviews have been received in 6 months. A lack of reviews could mean the business has closed, the name has changed, the location changed, etc. As such, an aggregate indicator measuring the volume and currency of a business' rating is desirable.

An Business Information Portal is described wherein numerous information portals are gathered, aggregated, summarized and provided to user in a simple and informative format. In one embodiment, the information in the Business Information Portal is segregate by neighborhood. In other words, streets, cites, states, or zip codes are unnecessary when defining geographic regions. In contrast, a neighborhood may span multiple streets, cities, townships, zip codes, counties, and even states. The geographic description of a neighborhood may have multiple criteria such as: 1) real estate boundaries, locally defined boundaries, and other information portals. Further, a neighborhood's bounds may be defined by one or more third party sources, by users and other sources. Each neighborhood may have a Neighborhood Portal within the Business Information Portal. For example, each Neighborhood Portal may comprise multiple information portals such as: general neighborhood information, business information, local news, alerts, pictures and videos, a local chat interface or information wall, jobs, real estate, events, etc.

Within each Neighborhood Portal are local business profiles. The information presented for each business profile may include aggregate data from multiple sources. For example, a business profile may comprise: user reviews from multiple review websites, news sources, press releases, social media, factual information of the business (owner, length of time in business, awards, accreditations, etc.), events, promotions, and targeted advertising. In one embodiment, the information presented for each business profile can be updated by the business owner, individual users and external information portals to name a few. As such, each time a user visits a business profile, the information is dynamically updated. Additionally, users may update information about each local business profile such as providing feedback and reviews to name a few.

Additionally, business owners may advertise to users via: 1) their individual business profile; 2) the local neighborhood profile where the business resides; and 3) targeted mobile ads. For example, when a user visits a local neighborhood profile, ads from local businesses within the neighborhood may be shown. Ads may include coupons and other incentives. Additionally, location-based ads may be pushed to a user's smart phone, tablet or other Internet-connected computing devices. For example, if a user is within a pre-defined geographic proximity to a business, an ad may be pushed to the user's smart phone offering them a discount if they visit the business.

Each business within the Business Information Portal may have a Business Score. In one embodiment, a Business Score is a numerical rating (e.g., 1 to 100) of a business. A Business Score may be derived, in real-time, from multiple information portals such as the Internet. For example, the Business Score may be derived from user reviews, BBB ratings, and accreditations to name a few. In one embodiment, a score of 95 indicates a highly praised business, whereas a score of 10 may be a poor score.

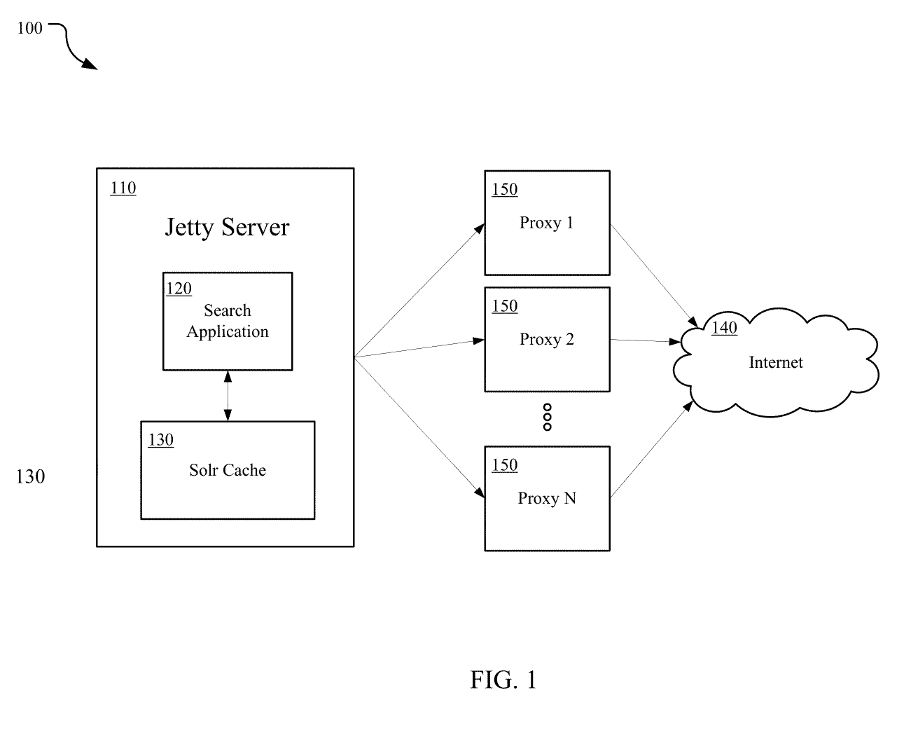

FIG. 1 illustrates a server architecture 100 configured for searching business information from multiple data sources. In one embodiment, the server architecture 100 comprises a search architecture and a data crawling architecture. In one embodiment, the search architecture may be the same as the information crawler architecture. Both the search and crawler architectures comprise a Jetty Server 110 having both a search application 120 and a Soft Cache 130. The Jetty Server 110 communicates with the Internet 140 via a pool of proxy servers 150. In one embodiment, the proxy servers 150 may be used to avoid obstruction by search engines (e.g., GOOGLE, YAHOO, BING, etc.) and data providers (e.g., YELP, MANTA, CITYSEARCH, PATCH, etc.) In one embodiment, the proxy server pool 150 may be used in a round robin basis for each HTTP request. For example, each HTTP request is initiated by a different proxy server.

In one embodiment, one proxy server may be removed from the pool of proxy servers 150 after a period of time (e.g., 1 hour) by stopping and restarting the proxy server and then placing it back in the pool 150. By restarting the proxy server, it receives a new IP address previously unknown by search engines and data providers. Such a strategy keeps IP addresses from becoming banned for continuous queries to a search engine or data provider.

In another embodiment, an information crawling server, such as Jetty Server 110, sharing a pool of proxy servers 150, may be obstructed or blocked by a search engine or data provider. All the proxy servers in the pool 150 may be stopped and restarted, resulting in all the proxy servers receiving new IP addresses. Such a method may ensure that no IP address is re-used.

One skilled in the art can appreciate that the Jetty Server 110 may comprise one or more servers. Additionally, multiple instances of the search application 120 may reside on one or more Jetty Servers 110. Further, one or more Soft Caches 130 may reside on one or more Jetty Servers 110, Also, the pool of proxy servers 150 may comprise one or more individual proxy servers, wherein each proxy server may be in communication with one or more Jetty Servers 110.

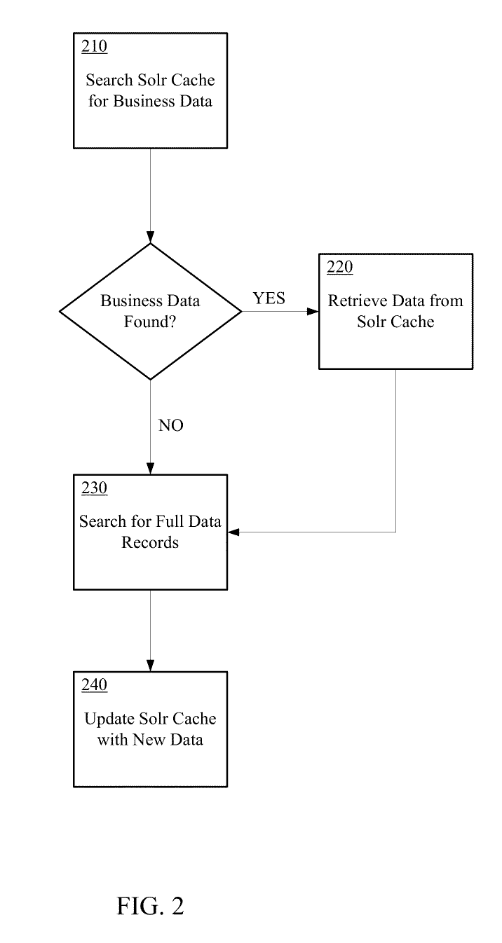

FIG. 2 illustrates a flow process for searching and gathering business information. In one embodiment, the search application 120 searches existing business profiles in the Soft Cache 130 (step 210.) In one embodiment, access to the search application is performed through one or more web services with two main methods: getFirstResult and getFullResults.

The getFirstResult method searches for results already stored in the Soft Cache 130 by a businessId. If results are found in the Soft Cache 130, they are returned to the search application 120 (step 220.) If no results are found in the Soft Cache 130, then a full business information search is performed by the getFullResults method (step 230.) In one embodiment, simultaneous and parallel crawling is performed for a pre-defined number of data providers. The first result set returned by the quickest data provider is pushed to the search application 120 with data from the remaining providers being crawled in the background until they complete.

In one embodiment, the getFullResults method returns the most recent results for all data providers without performing a Soft Cache 130 search. If the crawling was initiated earlier by invoking getFirstResult method, then it would take results from there. If not, the crawling would be started in parallel for all data providers and results would be returned after all provider processors have stopped processing. This method updates the Solr Cache 130 with the most recent data (step 240.) Appendix A illustrates one embodiment of a search application's data set.

In one embodiment, a crawler application, as described in FIG. 1, may be used to update the Soft Cache 130 with data independent from the search application. Crawling is performed against files prepared with each line representing a query line for the getFirstResult and getFullResults methods of Search. For example:

12302424, Meade's Restaurant, Peck Slip, New York, N.Y.

12302708, Mediterranean, 2 Ave, New York, N.Y.

12302841, Mei King Low Restrnt, 8 Ave, New York, N.Y.

Each file may be processed in its own thread, with each result stored in the Solr Cache, Proxies are shared between all threads, Before each business file is crawled, a check is performed to see if the businessId is already cached in the Solr Cache 130.

In one embodiment, Apache Soft 4.0 may be used as the Soft Cache for both the crawler application and the search application. However, other versions and platforms may be used. In one embodiment, the Solr application's war is installed on the same server as the data acquisition engine application which may allow for faster searching and updating. Within the schema, the url of the business provider's website may be used as the unique Id for each business profile. When searching in the Solr Cache 130, the businessId field is used. However, the business name, address, city and state fields may also be indexed to allow for faster searching on these fields. In one embodiment, the method for both the crawler application and search application may be the same. Below is an exemplary data scheme for a Soft Cache:

<field name=“id” type=“string” indexed=“true” stored=“true” required=“true” multiValued=“false”/>
<field name=“businessId” type=“string” indexed=“true” stored=“true” required=“false” multiValued=“false”/>
<field name=“name” type=“text_general” indexed=“true” stored=“true” required=“true” multiValued=“false”/>
<field name=“street_address” type=“text_general” indexed=“true” stored=“true” required=“true” multiValued=“false”/>
<field name=“city” type=“text_general” indexed=“true” stored=“true” required=“true” multiValued=“false”/>
<field name=“state” type=“text_general” indexed=“true” stored=“true” required=“true” multiValued=“false”/>
<field name=“address” type=“string” indexed=“false” stored=“true” multiValued=“true”/>
<field name=“picture” type=“string” indexed=“false” stored=“true” multiValued=“true”/>
<field name=“reviewGroup” type=“string” indexed=“false” stored=“true” multiValued=“false”/>
<field name=“contact” type=“string” indexed=“false” stored=“true” multiValued=“true”/>
<field name=“additionalDetail” type=“string” indexed=“false” stored=“true” multiValued=“true”/>
<field name=“source” type=“string” indexed=“false” stored=“true” multiValued=“false”/>
<field name=“category” type=“string” indexed=“false” stored=“true” multiValued=“false”/>
<field name=“starRating” type=“string” indexed=“false” stored=“true” multiValued=“false”/>

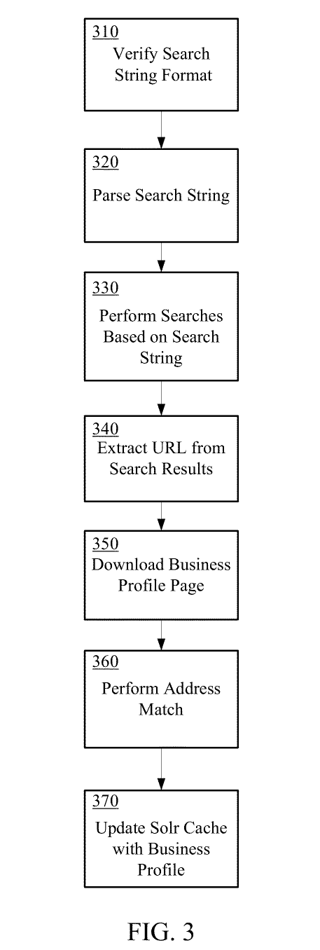

FIG. 3 illustrates a flow process for searching and extracting business information. When a business information request is received by a crawling application, as illustrated in FIG. 1, a verification step 310 checks to see whether the search string complies with the format “businessId, Name, Street Address, City, State” If the format is correct, the businessId is stored for future use and the rest of the string is split into Name, Address, City and State (step 320). Next, search engine searches are performed for the string “Name, Street Address, City, State” on pre-defined business information providers' sites such as yelp.com, citysearch.com, patch.com and manta.com (step 330). In one embodiment, processing may be done in parallel for each business information provider and target website. Next the search results are analyzed for the business provider URL links (step 340). If such a link is found, then the search result is captured and analyzed. In one embodiment, the search result is not analyzed unless the following conditions are met: 1) the city and state from the search snippet should have the full match with the requested city and state; and 2) the name should have at least a 50% word similarity with the requested name. In one embodiment, similarity may be found when two words have a 60% match, excluding common words.

Next, assuming a sufficient percentage match, the profile page is downloaded (step 350). For some data sources, such as MANTA and YELP, a cached YAHOO page may be used instead of the direct link. Next, the street address is checked on the downloaded profile page (step 360). In one embodiment, the profile should be processed if street name has a 70% match with the requested street name, excluding any house, apartment, unit numbers. In one embodiment, the profile page is crawled using XSLT. Lastly, the results are returned and the Soft Cache 130 is updated in the background using the businessId from the query (step 370).

Once data for each business is obtained, analyzed and aggregated, a unique value or score may be associated with each business. Throughout this application, the term “Business Score” may be used to describe an aggregate real-time value for a business based on currently available data Since data for each business is continuously captured and analyzed, the Business Score is dynamically calculated when a request for a business profile is received. In one embodiment, the Business Score is dynamically calculated based on a number factors related to web presence, social media profile, likes and reviews across disparate directory sites, etc. In one embodiment, the Business Score may be pre-computed and stored in the Solr Cache 130 while real-time crawling occurs in the background. This allows for a business profile page to load quicker with pre-computed information, while being updated real-time in the background. An exemplary process for calculating a Business Score is shown below, wherein a Business Score (BS) is based on the following:

Business Score (BS)=Wy*YELP score+Wc*CITYSEARCH score+Wp*PATCH score+Wt*TWITTER score+Wf*FACEBOOK score,

where:

1) Wy, Wc, Wp, Wt, Wf are weights for YELP, CITYSEARCH, PATCH, TWITTER, and FACEBOOK. In one embodiment, the sum of these weights should be 1. In one example, Wy=0.9, Wc=0.02, Wp=0.02, Wt=0.03, Wf=0.03.

2) YELP score=(Yelp_rating/Yelp_rating_max)*100, where Yelp_rating_max is the maximum rating on YELP (i.e., 5.)

3) CITYSEARCH score=CITYSEARCH rating, where the rating is between 1 to 100.

4) PATCH score=(Patch_rating/Patch_rating_max)*100, Patch_rating_max is the maximum rating on PATCH (i.e., 5.)

5) TWITTER score is based on the number of followers. If followers_num>0 and followers_num<50, then the TWITTER_score=25. If 50<followers_num<100, then the twitter_score=50. If 100<followers_num<1000, then twitter_score=75. If followers_num>1000, then the Twitter_score=100.

6) FACEBOOK score is based on the number of likes. If 0<likes_num<10, then the facebook_score=25. If 10<likes_num<50, then the facebook_score=50, If 0<likes_num<500, then the facebook_score=75. If likes_num>500, then the facebook_score=100.

In one example, a business may receive the following scores for BS=0.9*90+0.02*100+0.02*0+0.03*25+0.03*0=83.75. As such, the business received a BS of 83.75 out of 100. One skilled in the art can appreciate that the above exemplary process may be changed with respect to calculations, weighted factors and information portals without deviating from the scope of the invention.

In another embodiment, a Business Score may be calculated with the following process:

1. If an existing Business Score, is not available, use the YELP rating associated with a business.

2. Calculate the Business Rating based on:

Business Rating=(int)Math.Round(Math.Min(10, averageReviewRating+Math.Min((double)total/10, 0.1)+Math.Min((double)links.Count/7, 0.1)+Math.Min(FacebookLikes/10, 0.3) Math.Min(TwitterLikes/10, 0.3)));

Take the average review rating (review score/review count).

a) Add links count 17 but not more than a value of 0.1

b) Add FACEBOOK likes/10 but not more than a value of 0.3

c) Add TWITTER likes (followed count) but not more than a value of 0.3

3. Calculate Business Score based on:

BusinessScore=Math.Min(goodReviewCount, 40)+Math.Min(total, 10)+Math.Min(links.Count*3, 20)+Math.Min(AdditionalDetailsCount, 10)+Math.Min(FacebookLikes, 10)+Math.Min(TwitterLikes, 10);

a) Take the goodReview count (rating>=4) but not more than a score of 40.

b) Add total count of photos available on the web about this business spanning multiple authoritative sources but not more than a score of 10.

c) Add sources count×3 but not more than a core of 20.

d) Add additional detail count (when a lot if details about this business profile available on MANTA for example or elsewhere) but not more than a score of 10.

e) Add FACEBOOK likes count but not more than a score of 10.

f) Add TWITTER count of likes (followed) but not more than a score of 10.

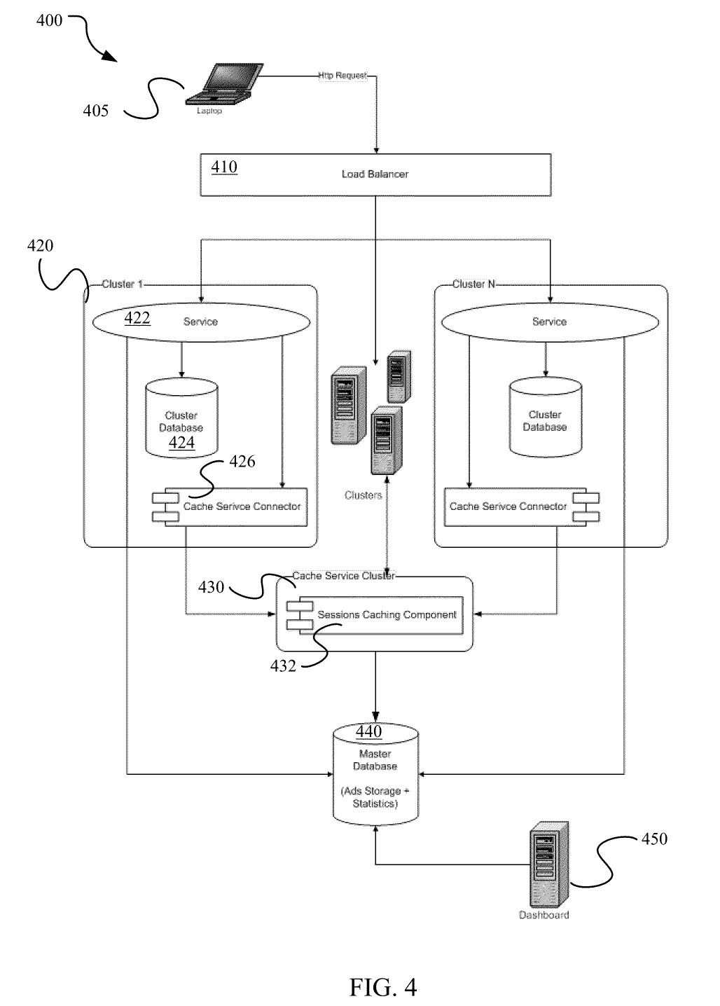

In order to accommodate growing needs for an Business Information Portal and its search and crawling applications, a scalable architecture is desirable. The system is scalable when additional resources (i.e., servers, databases, computers etc.) can be added without changing the code and recompiling the solution. FIG. 4 illustrates a scalable architecture 400 for an Business Information Portal. When a computing device 405 requests access to the Business Information Portal, the request is received by a Load Balancer 410, which determines which Cluster 420-N to relay the request. In one embodiment, the Cluster with the lowest load receives the HTTP request. Additional Clusters may be added to the system as needed. Each Cluster comprises the components necessary to process an HTTP request such as a Cache Service 422, a Cluster Database 424, and a Cache Service Connector 426. The Cluster Service 422 determines which methods and requests are expected to address the HTTP request. In one embodiment, the Cluster Database 424 is replicated from a Master Database 440. The Cache Service Connector 426 connects the Cluster 420 with a Cache Service Cluster 430 as a means of maintaining access to frequently used information between additional Clusters and the Master Database 440. The Cache Service Cluster 430 includes a Session Caching Component 432 used for saving session information that is subsequently used to fetch additional information such as advertisements. Lastly, the Master Database 440 stores the data used for the Business Information Portal. Web Server 450 accesses information from the Master Database 440 and presents the information to the Computing Device 405.

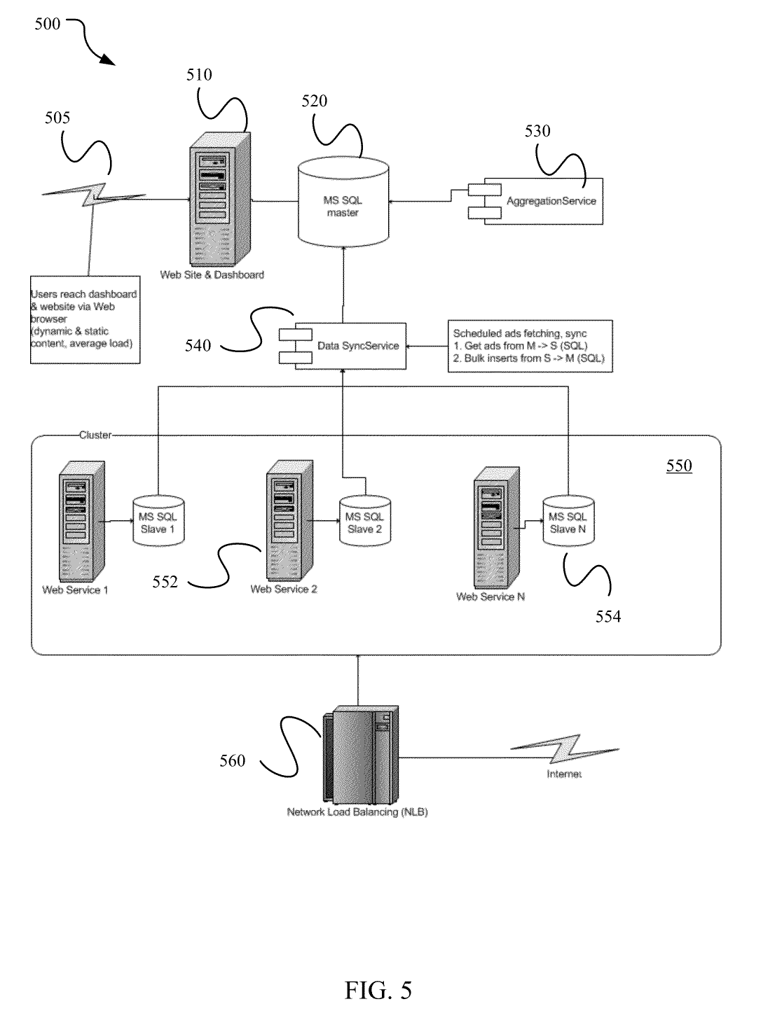

Another feature of a Business Information Portal is a Hyperlocal Mobile Ad Serving system. Users of the Business Information Portal may install a Mobile Ad application onto their smart phones or tablets via a Mobile Ad SDK. In one embodiment, the Mobile Ad application can push targeted and proximity-based advertisements to a smart device. FIG. 5 illustrates an embodiment of a server architecture for a Mobile Ad Service 500. Users access an Business Information Portal website and dashboard via a Website and Dashboard Server 510 via the Internet 505. In one embodiment, both the website and dashboard services are located on the same server 510. In another embodiment, they can be located on separate servers. The Website and Dashboard Server 510 receives information from a Master Database 520. An Aggregation Service 530 aggregates data displayed on the dashboard in order to provide faster load times of impressions and dicks. The Master Database 520 communicates with a Cluster 550 via a Data Sync Service 540. The Cluster comprises one or more Web Service Servers 552 each having a Slave Database 554. A Network Load Balancer 560 directs each request to one of the Web Service Servers 552 within the Cluster 550. Each of the Slave Databases 554 have data for fetching ads, registering clicks and impressions. Lastly, the Data Sync Service 540 synchronizes dicks and impressions to the Master Database 520 as well as pushing new advertisements to each of the Slave Databases 554 for eventual push to client devices.

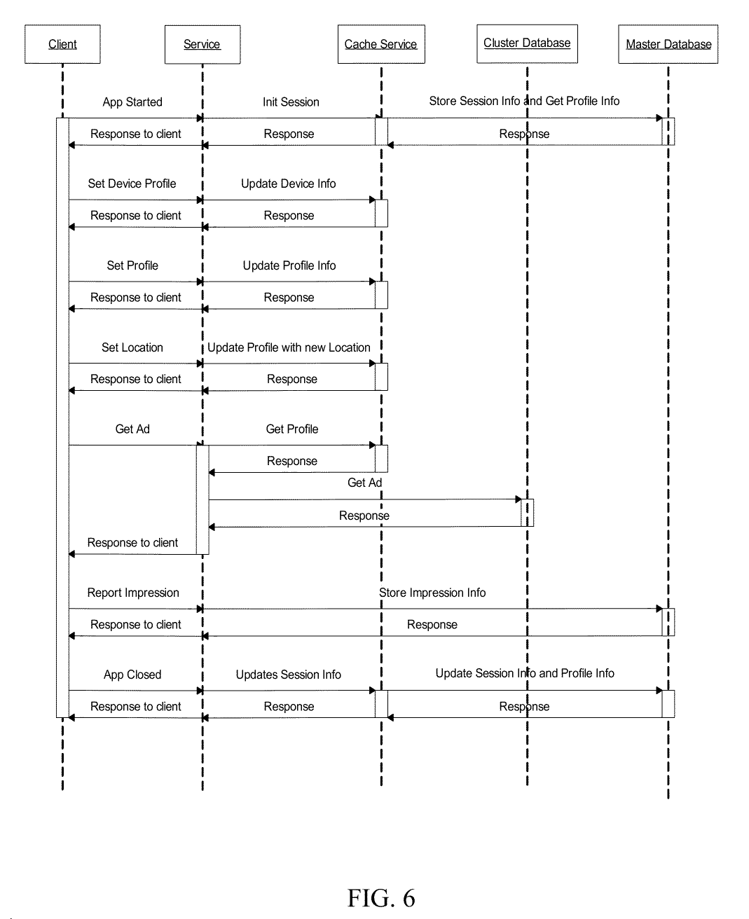

FIG. 6 illustrates services used to receive and process advertisement requests from a client computing device.

With respect to a Business Score, as discussed above, it can be beneficial to know how current a business' numerical rating is. For example, if a restaurant hasn't received any ratings from GOOGLE PLACES in the past six months, does this mean the restaurant is closed or maybe unpopular? Based on the lack of recent ratings from GOOGLE PLACES, a user may assume the restaurant is not worth visiting. However, it is possible that YELP has many recent reviews for the same restaurant. Under this scenario, the user would've missed the opportunity based on insufficient reviews from only searching GOOGLE PLACES.

In another example, a user sees that a restaurant has numerous reviews on YELP, and considers the restaurant a good choice. However, the restaurant may have closed 3 months earlier wherein the user was not aware. If the user looked closely he/she would've notice that there have not been any reviews in 4 months. As such, an aggregate indicator of a buiness' current online activity may be useful. Throughout the application, the term “Health Score” refers to an aggregate value of a business' online presence based on factors such as online events, the frequency of these events and the timeframe of these events.

In one embodiment, a Health Score is a numeric value (i.e., 1-100), wherein 1 may indicate the business is closed. A score of 25 may indicate some recent activity and a score of 80 may indicate significant recent activity. In another embodiment, the Health Score may be based on a color. For example, a color of red may indicate the business is closed, a color of yellow may indicate some recent activity and green may indicate significant recent activity.

In one embodiment, a Health Score is determined by extracting information, about a business, from one or more information portals and aggregating the information into a value. In order to provide a Health Score, one or more processes for finding and aggregating such information are described. Additionally, the process for determining whether a business is closed may differ from the process for determining the current online activity for a business. As such, different embodiments are described for determining business activity levels and whether it is closed.

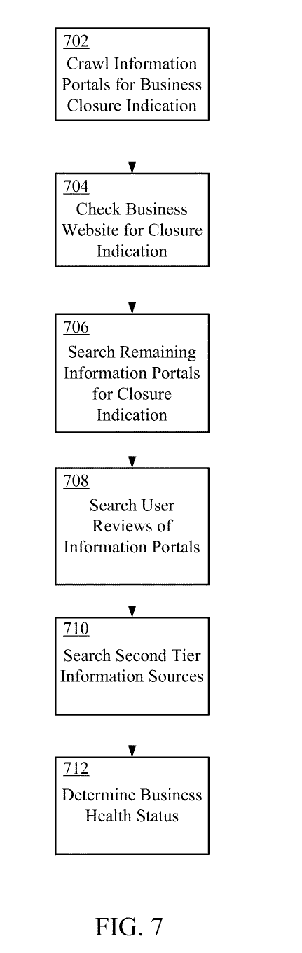

It can be difficult to determine, from online sources, whether a business is closed. The business may still maintain a website without indicating its closure. The business may have removed its website altogether. Or possibly the business never maintained a website. Other information portals may or may not provide information surrounding a business closure. If some of these sources do mention something about a business and an alleged closure, it can be difficult to ascertain the source's validity. For example, YELP may indicate a business has closed, yet FOURSQUARE may indicate recent activity about users “checking in” at the business. Such disparate information can be confusing to users seeking information on the business. As such, FIG. 7 illustrates a flow process for determining whether a business is closed.

First, one or more information portals are crawled to find information regarding a business' closure (step 702). If one or more information portals indicate a business is closed, the business' Health Status is flagged as “likely closed” and the business' website is checked for a closure indication (step 704). In one embodiment, the crawler may search the remaining pre-defined information portals for an explicit indication of the business' closure (step 706.) If one or more information portals indicate the business as “closed”, the business' health status is flagged as “closed.”

If additional closure indicators are not found, the crawler may search secondary information from the information portals for additional indicators of a business closure (step 708). In other words, YELP and other information portals may not immediately indicate that a business is closed. However, it is possible that user reviews or news articles (maintained on the information portal) of the business may indicate the business as closed.

In one embodiment, if one or more information portals indicate a business as closed, the process ends. In another embodiment, if the pre-determined information portals do not indicate a business as closed, additional searching may be done on a second tier of information sources. In another embodiment, additional searching may be done to further validate the closure of a business from the portal search. A secondary search is used to search secondary information sources for a closure indicator (step 710). In one embodiment, secondary sources may include FACEBOOK, TWITTER and the Internet as a whole. If a secondary search indicates a business as closed, the business' Health Score may be labelled as “closed.” In one embodiment, the secondary search crawls numerous secondary information sources based on keywords such as “closed”, “out of business”, “bankrupt” and others. Further details of such a search are described below. Next, the business' health status is determined and marked as such (step 712). In one embodiment, if the neither the primary search and/or secondary search indicate a business as closed; the business' online indicator may be labelled as “still open,” In one embodiment, further searches are done to determine the activity level of the business, In other words, it is beneficial to know the activity level of an opened business.

In another embodiment, the neighborhood-centric information portal located at http://www.localblox.com may be searched for indicators of a business closure. Localblox divides the United States into 100,000+ distinct neighborhoods. If a business closes in a specific neighborhood, it is possible a member of that neighborhood will mention the same the closure on the Localblox website. In yet another embodiment, users of one or more information portals may be given an incentive to provide information about business closures. This incentive may increase the speed and number of indicators of a restaurant's closure.

In one embodiment, the following formulas may be used for determining whether a business is closed.

C=C1*C2* . . . *Cm* . . . *CM

Cᵢ=0 if closed; C=1 if not closed

C=0 if at least one information portal provides an explicit indication of a business as closed; C=1 if there is no dear indication

m=1 . . . M−index of the time interval, where M is the number of information portals monitored for a “business closed” indicator

C=the criterion for “closed” indicator. For example, C1=0 if YELP indicates the business is closed; else C1=1. C2=0 if MANTA indicates the business as closed. C3=1 if Yellowpages.com indicates the business as open.

In one embodiment, a weight is given to different information portals and/or the type of indicator found within each information portal. For example, user reviews for a business in YELP may be given a greater weight than YELP's standard business profile. In other words, if YELP's business profile does not indicate a business as closed, but one or more user reviews indicate the business is closed, the user reviews may be given more weight. Alternatively, a second information portal, such as MANTA's business profile may be given more weight than user reviews. Additionally, the number of FACEBOOK “likes” or FOURSQUARE “check-ins”, over a period of time, may be used in determining whether a business is still opened.

If a business is not closed, it is beneficial to know how much online activity or events are associated with the business, Online activity may be an indicator of the popularity of a business. For example, a restaurant that has received numerous FACEBOOK “likes” and MANTA reviews, over the past few months, may be a good indicator that the restaurant is popular. On the other hand, a restaurant with little to no activity may indicate the restaurant's lack of a following. In one embodiment, the criteria and processes for determining the online activity of a business may differ from the process used to determine if a business is closed.

Time periods or time intervals may be one factor for determining a business' Health Score. The more recent a business' online activity, the more weight that may be given to the Health Score.

Ti=the number of days within a time interval of i

i=1 . . . N; where N is the number of monitored time intervals.

For example:

(1 day) T1=1

(1 week) T2=7

(1 month) T3=30

(3 months) T4=90

(6 months) T5=180

(1 year) T6=360

If a business received an online event in the past week, the value of the event may be greater than an event from 2 months ago.

Another factor for determining a business' Health Score is event counts. The more online events a business has, the higher a business' Health Score may be, In one embodiment, an event is any online activity associated with the business or any mention of the business. For example, an event could include a FACEBOOK “like”, a “Tweet”, an online review, the posting of a photo or video tagging the business or changes to the business' profile from information portals. In one embodiment, a business' Health Score may be based on the number of events within a period of time.

Eik=the number of events for he business within a time interval i on authority site k monitored for events.

Ek=E1k+E2k/2+ . . . +ENk/N−number of all events within all monitored time periods on site k monitored for events.

E=E1+E2+ . . . +Ek+ . . . +EL

K=1 . . . L−index of sites monitored for events

L=the number of sites monitored for events

E=the number of events against all services

Ok=(E1k)/T1+(E2k−E1k)/2*(T2−T1)+ . . . +(Eik−E(i−1)k)/3*(Ti−T(i−1))+ . . . (ENk−E(N−1)k)/N*(TN−T(N−1))

K=1 . . . L−index of sites monitored for events

I=1 . . . N−index of time interval

This criterion is based on the number of events for the period. The further back in time an event takes place, the less the event will influence the Health Score.

O=(O1+ . . . +Ok+ . . . +OL)/E

O=[0;1]

O depends on the number of recent events. The later the event date—the less it affects the O criterion.

In one embodiment, a “closed/open” indicator and the number of events. within a time period may be used to determine a complete Health Score “R”, where:

R=(C/2+O/2)*100

R=[0;100]

If at least one of the authority sites indicate the business as “closed” the business' C value is C=0. In this case, R depends on O. The more events associated with the business, the higher a business' O value becomes (Le., close to 1.) In this scenario, the business' Health Score (“R”) is approximately 50 points.

In another example, if a business' C value=1 (i.e., no authority sites show the business as closed) and there are no events during a time period, the business' Health Score “R” may still receive close to 50 points. In another embodiment, if C=0 (i.e., one or more authority sites show the business as closed) and there are no events during a time period, the business' Health Score “R” may be close to zero. In yet another embodiment, if C=1 (i.e., no authority sites show the business as closed) and there are many events in a given time period, the business' Health Score “R” may be close to 100.

The above processes are mere examples for calculating a Health Score. Different authority sites, information portals and weights may be used without deviating from the scope of the invention, Once a Health Score is calculated, it's value may be used in calculating the overall Business Score of a business.

In another embodiment, it is beneficial to know when a business' location changes. As described above with respect to FIG. 2, business location information is stored in a Solr Cache. In order to determine any business location changes, it is beneficial to verify business addresses against information portals and/or the business websites. In one embodiment, a business' address is obtained from one or more information portals. The address stored in the Solr Cache is cross-referenced with the address from the one or more information portals. If discrepancies are discovered, further searches may be used to resolve the issue.

In one embodiment, web crawlers may be used to search the information portals for new businesses. For example, the Solr Cache of FIG. 2, stores business information for a specific number of business in specific geographic locations (e.g., neighborhoods.) A web crawler may query one or more information portals for all businesses within a specific geographic region. If the prior number of business for the region is the same as returned from the portal(s), then no new businesses are found. However, if the number of businesses returned from the search is greater than the stored number of business, then at least one new business is found. Information about the business is then added to the Solr Cache.

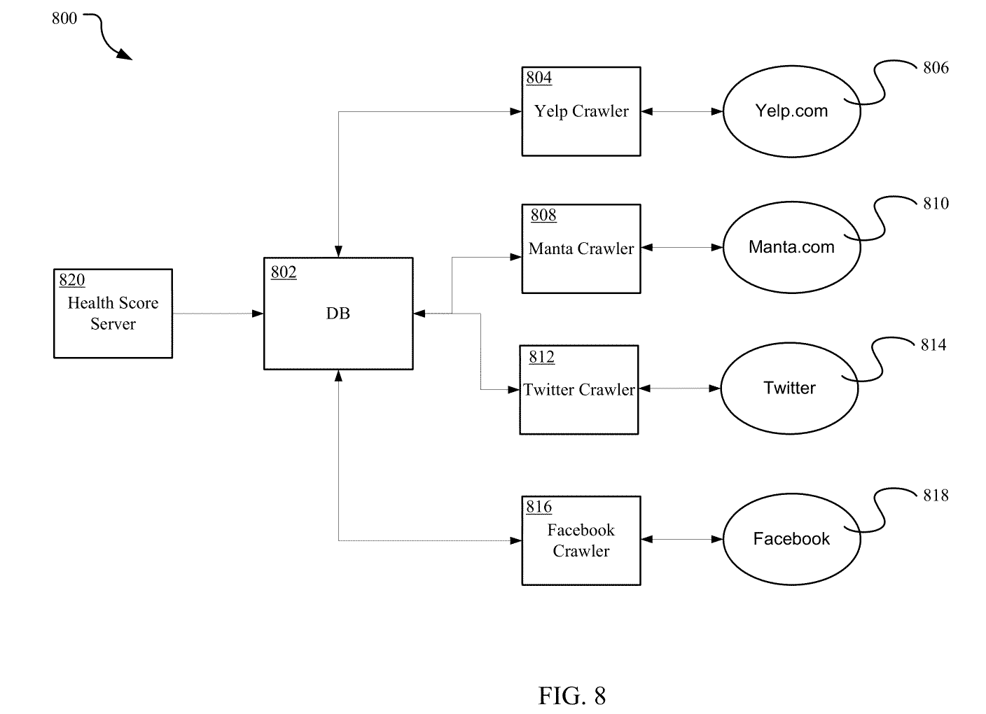

In order to implement a system for calculating a Health Score, one or more computer systems are utilized to gather the necessary information. FIG. 8 illustrates a computing system for calculating a business' online activity. Computing system 800 comprises a database 802 for storing information from one or more web crawlers. In one embodiment, the database 802 may represent a plurality of database servers for storing the information extracted from web crawlers.

A YELP Crawler 804, a MANTA Crawler 808, a TWITTER Crawler 812, and a FACEBOOK Crawler 816 couple to the Database 802. The YELP Crawler 804 crawls the yelp.com website 806 for information related to one or more businesses. The MANTA Crawler 808 crawls the manta.com website 810 for information related to one or more businesses. The TWITTER Crawler 812 crawls the TWITTER information portal 814 and the Internet for “TWEETS” associated with one or more businesses. The FACEBOOK Crawler 816 crawls the FACEBOOK information portal for information associated with one or more businesses. In one embodiment, additional crawlers may be used to search for specific information portals. For example, a YELLOWPAGES Crawler and a FOURSQUARE Crawler could be added. In another embodiment, one or more of the Crawlers described in FIG. 8 are not included. In another embodiment, Crawlers 804, 808, 812 and 816 may refer to a plurality of servers per information portal. In other words, the FACEBOOK Crawler 816 may comprise dozens of servers. Additionally, one or more proxy servers (not shown) may couple between one or more Crawlers and their associated information portals. Proxy servers may be used to hide the source of a Crawler.

A Health Score Server 820 couples to the Database 802 and processes the information stored therein. The Health Score Server 820 further computes a Health Score for one or more businesses based on the information retrieved from one or more Crawlers. In one embodiment, the Health Score Server 820 may comprise a plurality of servers and a load balancer.

In one embodiment, a Health Score is given a timestamp. Since a Health Score is determined through information received from the Crawlers 804, 808, 812 and 814, the date of the extracted information becomes important. In other words, if a Health Score is based on data received today, the score may be more accurate than a Health Score based on data received three weeks ago, Thus, it is desirable to determine the correct frequency of searches based on the cost of esources and the importance of fresh information.

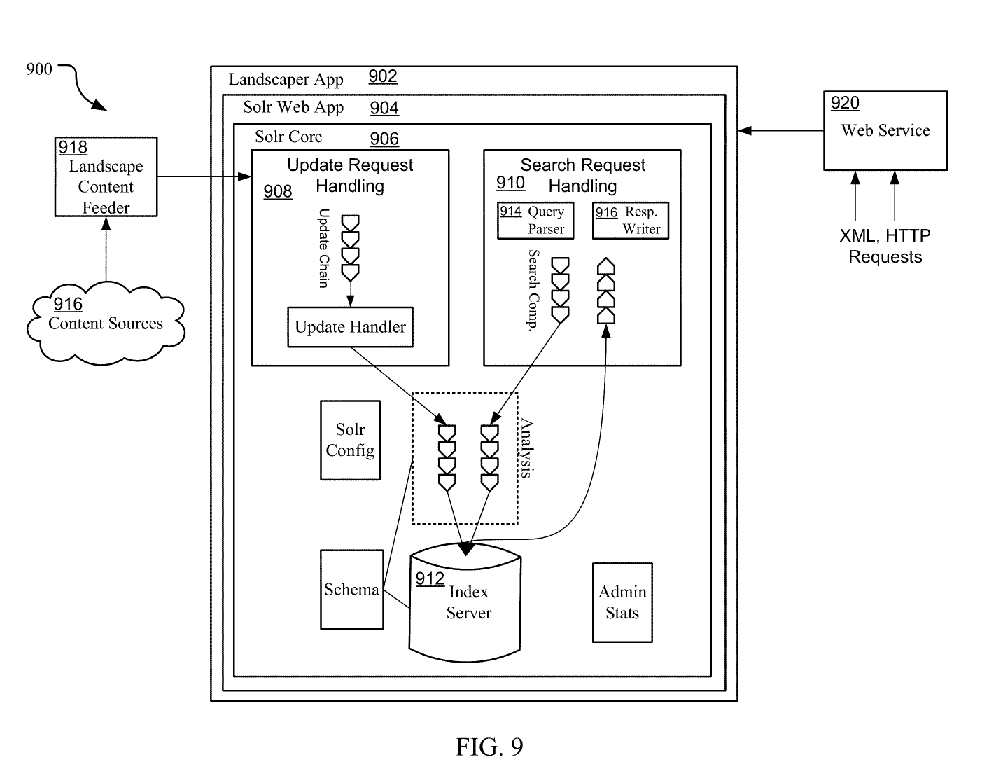

It is desirable to have a well-defined system architecture for receiving and processing client requests for local business information, FIG. 9 illustrates an architecture for a local business search solution 900. The architecture comprises a Landscaper Application 902. Within the Landscaper App is Solr Web Application 904. Within the Solr Web Application 904 is a Solr Cache 906. Within the Solr Cache 906 is an Update Request Handling Module 908, a Search Request Handling Module 910 and an Index Data Store 912 where information for local business is stored. In one embodiment, the Index Data Store 912 is an Apache Lucene Search Core.

The Landscaper App 902 provides users a Web Service 920, via Web Service Definition Language (“WSDL”), where users can requests information about a business. As such, client requests are submitted to the Landscaper App 902 via the Web Service 920. In one embodiment, client requests are sent in Simple Object Access Protocol (“SOAP”). When a request is received, the Search Request Handling Module 910 receives the request, parses the request (via Query Parser 914), and submits the parsed request to the Index Data Store 912. In one embodiment, the search request is built into a query for the Solr Core and sent via HTTP. The desired local business information is then given to the Search Request Handling Module 910, via a Response Writer Module 916. In one embodiment, the search results are transformed into a SOAP result model and then sent to the client.

In another embodiment, if the Index Data Store 912 does not comprise the desired content from a query, Content Sources 916 are queried (via Landscaper Content Feeder 918), for the desired information. Once the desired information is found, it is written to the Index Data Store 912 (via Update Request Handling Module 908). Once the desired information has been stored in the Data Store 912, it is pushed to the user as described above. In one embodiment, documents are imported into the Data Store 912 in a JavaScript Object Notation (“JSON”) format. However, other formats may be used such as XML, text files, etc.)

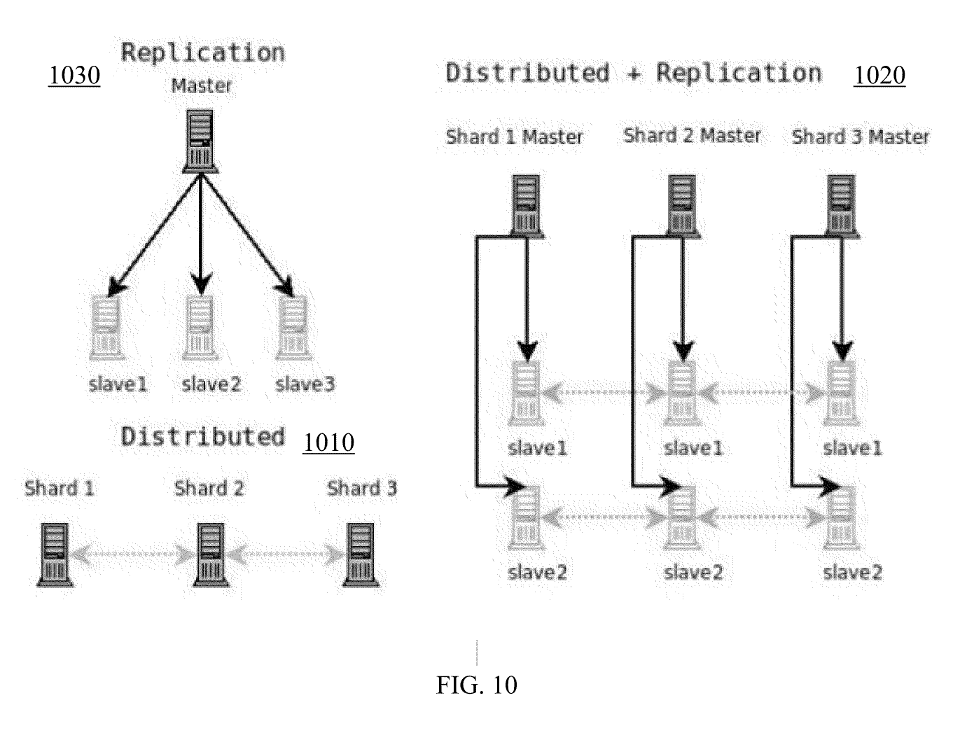

In order for a searching architecture to be effective, it must be easily scalable. FIG. 10 illustrates an example of scalable architecture 1000 for searching for business information. Throughout FIG. 10, the scalability discussions are based on Lucene and Solr servers. However, one skilled in the art can appreciate that additional platforms and solutions may be used without deviating from the scope of the invention. In one embodiment, a single server machine, as illustrated in FIG. 9, can likely host a Lucene/Solr index of 5-80+ million documents, while a distributed solution can provide sub second search response times across billions of documents. Over that range, query throughput can be adjusted with index replication at each individual server.

In one embodiment, a Distributed Model 1010 is described for scaling a Lucene/Solr index across a distributed configuration begins with maximizing performance on a single server machine, Next, absorb high query volume by replicating to one or more additional server machines. When the Lucene/Solr index becomes too large for a single server machine, split the index across multiple server machines (or shard the index). Finally, for high query volume and large index size, replicate each server node within a distributed configuration.

A Master/Slave Distributed+Replication Model 1020 is described for scaling a Lucene/Solr index across a configuration. In such a configuration, the master server(s) handles updates and replicates all index changes to the slave servers. Generally, the slave server handle the query requests. An index can be split across multiple machines (called shards when using distributed Solr), where each shard will handle index updates and queries. Each shard can be configured for replication, wherein each shard master handles updates, and the slaves of each shard handle query requests.

In a Replication Model 1030, there is a master server, which handles update requests, and one or more slave servers that handle query requests. The master server may periodically takes snapshots of the index, literally freezing a view of the index in time. The slave servers then poll the master server to determine if there is a new snapshot to download. If there is, any changed files will be transferred from the master server to the slave server and Soft will open a new view on the updated index (with cache auto warming and everything else that normally goes on with a single machine index view update).

Using this model, Soft can easily scale horizontally by adding more slave servers as to handle additional load requirements. In one embodiment, a load balancer may be added to assign a single virtual IP address that resolves to the IP address of each of the slave servers as requests are received.

Unless specifically stated otherwise, as apparent from the following discussion, it is appreciated that throughout the description, discussions utilizing terms such as processing or “computing” or “calculating” or “determining” or “displaying” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices.

The exemplary embodiments can relate to an apparatus for performing one or more of the functions described herein. This apparatus may be specially constructed for the required purposes, or it may comprise a general purpose computer selectively activated or reconfigured by a computer program stored in the computer. Such a computer program may be stored in a machine (e.g. computer) readable storage medium, such as, but is not limited to, any type of disk including optical disks, CD-ROMs and magnetic-optical disks, read only memories (ROMs), random access memories (RAMS) erasable programmable ROMs (EPROMs), electrically erasable programmable ROMs (EEPROMs), magnetic or optical cards, or any type of media suitable for storing electronic instructions, and each coupled to a flash memory device, such as a compact flash card or USB flash drive.

Some exemplary embodiments described herein are described as software executed on at least one computer, though it is understood that embodiments can be configured in other ways and retain functionality. The embodiments can be implemented on known devices such as a server, a personal computer, a smart phone, a tablet device, a special purpose computer, a programmed microprocessor or microcontroller and peripheral integrated circuit element(s), and ASIC or other integrated circuit, a digital signal processor, a hard-wired electronic or logic circuit such as a discrete element circuit, or the like. In general, any device capable of implementing the processes described herein can be used to implement the systems and techniques according to this invention.

It is to be appreciated that the various components of the technology can be located at distant portions of a distributed network and/or the internet, or within a dedicated secure, unsecured and/or encrypted system, Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof, or any other known or later developed element(s) that is capable of supplying and/or communicating data to and from the connected elements. The terms determine, calculate and compute, and variations thereof, as used herein are used interchangeably and include any type of methodology, process, mathematical operation or technique.

The invention described and claimed herein is not to be limited in scope by the specific embodiments herein disclosed since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. All publications cited herein are incorporated by reference in their entirety.

What is claimed is:

1. An apparatus for generating a business score for display on a video display, the apparatus comprising:
a CPU coupled to a memory for executing software instructions;
a network interface coupled to the CPU for data communications;
a display device, coupled to the CPU, for providing information to a user of the device; and
a machine readable storage, coupled to the CPU, containing software modules programmed for:
receiving a first rating (R1) for a business from a first data source, wherein the first rating is based on a numeric value from a maximum possible value (R1_{MAX});
assigning a first weighted value (W1) to the first rating;
receiving a second rating (R2) for the business from a second data source, wherein the second rating is based on a numeric value from a maximum possible value (R2_{MAX});
assigning a second weighted value (W2) to the second rating, wherein the first weighted value and the second weighted value equal 1;
calculating the business score (BS) for the business based on the following calculation:
BS=(((R1/R1_{MAX})*100)*W1)+(((R2/R2_{MAX})*100)*W2);
and
communicating the business score to a video display communicatively coupled to the apparatus.

2. The apparatus of claim 1, wherein the software modules are further programmed for:
receiving a third rating (R3) for he business from a third data source,
wherein the third rating is based on a number of electronic followers of the business, wherein the third rating has a maximum value of 100;
assigning a third weighted value (W3) to the third rating, wherein the sum of W1, W2 and W3 equal 1; and
recalculating the business score based on the following calculation:
BS=(((R1/R1_{MAX})*100)*W1)+(((R2/R2_{MAX})*100)*W2)+(R3*W3).

3. The apparatus of claim 2, wherein the number of electronic followers is based on the number of FACEBOOK Likes.

4. The apparatus of claim 2, wherein the number of electronbic followers is based on the number of TWITTER Followers.

5. The apparatus of claim 1, wherein the business score is a numeric value between 1 and 100.

6. The apparatus of claim 1, wherein the business score is a color coded indicator based on a numeric value.

7. An electronic system for generating a business score for display on a video display, the system comprising:
a server computing device; and
a client terminal device, in communication with the server over a network, containing machine readable storage;
wherein the server includes a machine readable storage containing software modules programmed for:
receiving a first rating (R1) for a business from a first data source, wherein the first rating is based on a numeric value from a maximum possible value (R1_{MAX});
assigning a first weighted value (W1) to the first rating;
receiving a second rating (R2) for the business from a second data source, wherein the second rating is based on a numeric value from a maximum possible value (R2_{MAX});
assigning a second weighted value (W2) to the second rating, wherein the first weighted value and the second weighted value equal 1;
calculating the business score (BS) for the business based on the following calculation:
BS=(((R1/R1_{MAX})*100)*W1)+(((R2/R2_{MAX})*100)*W2);
and
communicating the business score to a video display communicatively coupled to the server.

8. The electronic system of claim 7, wherein the software modules are further programmed for:
receiving a third rating (R3) for the business from a third data source,
wherein the third rating is based on a number of electronic followers of the business, wherein the third rating has a maximum value of 100;
assigning a third weighted value (W3) to the third rating, wherein the sum of W1, W2 and W3 equal 1; and
recalculating the business score based on the following calculation:
BS=(((R1/R1_{MAX})*100)*W1)+(((R2/R2_{MAX})*100)*W2)+(R3*W3).

9. The electronic system of claim 8, wherein the number of electronic followers is based on the number of FACEBOOK Likes.

10. The electronic system of claim 8, wherein the number of electronic followers is based on the number of TWITTER Followers.

11. The electronic system of claim 7, wherein the business score is a numeric value between 1 and 100.

12. The electronic system of claim 7, wherein the business score is a color coded indicator based on a numeric value.

13. An apparatus for generating a business health score for display on a video display, the apparatus comprising:
a CPU coupled to a memory for executing software instructions;
a network interface coupled to the CPU for data communications;
a display device, coupled to the CPU, for providing information to a user of the device; and
machine readable storage, coupled to the CPU, containing software modules programmed for:
determining if a business is closed and generating a closed indicator (A1);
determining a first number of events for the business from a first data source and generating a first event value (E1);
determining a second number of events for the business from a second data source and generating a second event value (E2);
calculating the health score (HS) for the business based on the calculation of HS=A1+E1+E2; and
communicating the health score to a video display communicatively coupled to the apparatus.

14. The apparatus of claim 13, wherein the step for determining if a business is still in business further comprises:
querying one or more business information portals for an indication that the business is closed; and
querying the Internet for indications whether the business is closed.

15. The apparatus of claim 13, wherein the closed indicator has a value of 0 if the business is closed and a value of 50 if the business is still in business.

16. The apparatus of claim 13, wherein each W1 and W2 have a maximum value of 25.

17. The apparatus of claim 13, wherein the software modules are further programmed for:
assigning a first weighted value (W1) to the first event value;
assigning a second weighted value (W2) to the second event value;
wherein the sum of W1 and W2 are 1; and
recalculating the health score based on the calculation of
HS=A1+E1*W1*2+E2*W2*2.

18. The apparatus of claim 13, wherein E1 and E2 are influenced by the number of events over a period of time.

19. The apparatus of claim 13, wherein an event is an Internet-based activity associated with the business.

20. The apparatus of claim 19, wherein an event is one of: a user generated review, a FOURQSUARE check-in, a TWEET, a FACEBOOK post about the business, a news article, a FACEBOOK check-in.
